(19) United States
(12) Patent Application Publication
(10) Pub. No.: US 2019/0233674 A1
(43) Pub. Date: Aug. 1, 2019

(54) Hydrophobic Xerogel Film and Method of Use Thereof For Reducing Condensation

(71) Applicant: Mirapakon Inc., Quebec (CA)

(72) Inventors: Olivier Marion, Quebec (CA); Gary Whipp, Quebec (CA)

(21) Appl. No.: 16/331,632

(22) PCT Filed: Sep. 8, 2017
(86) PCT No.: PCT/CA2017/051056

§ 371 Date: Mar. 8, 2019

Related U.S. Application Data
(60) Provisional application No. 62/385,444, filed on Sep. 9, 2016.

(51) Int. Cl. C09D 183/08; C08G 77/24

(52) U.S. Cl. CPC C09D 183/08; C08G 77/24

(57) ABSTRACT

The present disclosure generally relates to condensation-reducing hydrophobic xerogel films. More particularly, the invention relates to hydrophobic ORMOSIL (organically modified silica) condensation-reducing film.

### FIELD OF THE DISCLOSURE

The present invention generally relates to condensation-reducing hydrophobic xerogel films. More particularly, the invention relates to hydrophobic ORMOSIL (organically modified silica) condensation-reducing film.

### BACKGROUND OF THE DISCLOSURE

Condensation is a physical process that occurs at interfacial boundaries under conditions of high humidity when there is a large temperature difference. One of the most common scenarios happens when water vapor is cooled to its saturation limit, such as when air comes into contact with a cold surface. The cooling effect leads to deposition of water on the surface because the air can no longer hold as much water vapor.

Condensation in buildings is often an undesirable phenomenon leading to dampness, wood rot, corrosion and other problems. On a surface, dew can also promote the growth of mildew and bacteria. Furthermore, the formation of condensate on the ceilings, walls and working structures of high-volume buildings such as food processing factories and storage spaces is a particular problem since dripping water can be a source of contamination by pathogens.

Many attempts have been made to solve condensation problems. Application of different forms of insulating material increases construction costs, can lead to new problems and sometimes is simply not practical. For instance, it is impossible to implement traditional isolation techniques on moving steel parts in a factory, on electronic components, on telecommunication devices, on ship decks or on the exterior of armoured vehicles.

The dew problems can be resolved by controlling the surface wettability either by augmenting the hydrophilicity or by augmenting the hydrophobicity of the surface. Highly hydrophilic coatings that reduce the tendency for a surface to form condensation have been reported. In different industries, these coatings are used in locations prone to high moisture content such as bathrooms, caravans, yachts, underground parking lots, cold storage rooms, water tanks, grain silos and food processing plants. Usually, these coatings improve the wettability of the surface by forming a continuous thin layer of water film on the surface instead of discrete droplets. However, these coatings have low moisture absorptivity, long moisture release time, poor film hardness, inefficient fabrication processes, long curing time and inadequate weathering resistance. Also, highly hydrophilic materials are prone to corrosion and are notably difficult to wash because of their elevated surface energy.

Hydrophobic coatings have an advantage over hydrophilic coatings since they can reduce the formation of water droplets and protect the surface against corrosion.

### SUMMARY OF THE DISCLOSURE

The present disclosure provides a combination of silanes, a sol-gel matrix obtained from said silanes as well as surface coating compositions (also referred to as ORMOSIL films) comprising said combination of silanes or sol-gel matrix that can be used to generate a xerogel film.

The present disclosure also provides a method for reducing or preventing formation of water condensation on a solid surface.

In an aspect, the present disclosure provides sol-gel matrix based surface coatings. The xerogel film is prepared from a sol-gel matrix obtained from partial hydrolysis of silanes (e.g., long-chain alkyltrialkoxysilanes, short-chain alkyltrialkoxysilanes, aminoalkyltrialkoxysilanes, alkylaminoalkyltrialkoxysilanes, dialkylaminoalkyltrialkoxysilanes, and perfluororalkyltrialkoxysilanes) composition. The surface coatings are used in a method for reducing or preventing formation of water condensation on said surface. The coatings are two-, three- or four-component ORMOSIL (organically modified silica) xerogel films (also referred to herein as hybrid films). The xerogel films can be formed by sol-gel methods, such as the methods disclosed herein. In an embodiment, a condensation-reducing surface coating composition comprises a sol-gel matrix. The sol-gel composition comprises two, three or four silanes.

The present disclosure provides methods for reducing or preventing formation of water condensation on a solid surface, comprising providing a xerogel film as defined herein, on at least a portion of said surface.

### DETAILED DESCRIPTION

The present disclosure uses a combination of silanes, a sol-gel matrix obtained from said silanes as well as condensation-reducing coating compositions comprising said combination of silanes or sol-gel matrix, that can be used to generate a xerogel film. The present disclosure provides methods for reducing or preventing formation of water condensation on a solid surface using the combination of silanes, the sol-gel matrix or composition described herein.

As used herein, a sol-gel matrix comprises two or more silanes, some of which have been partially hydrolyzed (i.e. some of the alkoxy groups on the silanes having been hydrolyzed to hydroxyl groups), and/or condensed (i.e. at least some of the Si—OH have Si—O—Si bonds), therefore leading to small oligomers comprising siloxane groups derived from the partially hydrolyzed silanes.

Preferably, the sol-gel matrix is obtained from mixing a combination of silanes and a catalyst for partially hydrolyzing alkoxy groups on the silanes. In one embodiment, the catalyst is an acid, such as an aqueous acid.

As used herein, a composition comprises a combination of silanes or a sol-gel matrix as defined herein and an organic solvent.

Preferably, the solvent is a water miscible solvent. In one embodiment, the solvent is an alcohol or a mixture of alcohols. Non-limiting examples include methanol, ethanol, isopropanol or mixtures thereof.

In one embodiment, the composition as defined herein, is prepared by mixing a combination of silanes and a catalyst for partially hydrolyzing alkoxy groups on the silanes, wherein said catalyst is an aqueous acid in admixture with a water miscible solvent.

In one embodiment, the molar amount of catalyst for partially hydrolyzing alkoxy groups is from about 0.001 mol % to about 10 mol %.

Alkyl group as used herein, unless otherwise expressly stated, refers to branched or unbranched saturated hydrocarbons. Examples of alkyl groups include methyl groups, ethyl groups, n-propyl groups, i-propyl groups, n-butyl groups, i-butyl groups, s-butyl groups, pentyl groups, hexyl groups, octyl groups, nonyl groups, and decyl groups and octadecyl groups. The alkyl group can be unsubstituted or substituted with groups such as halides (—F, —Cl, —Br, and —I), alkenes, alkynes, aliphatic groups, aryl groups, alkoxides, carboxylates, carboxylic acids, and ether groups. For example, the alkyl group can be perfluorinated.

Alkoxy group as used herein, unless otherwise expressly stated, refers to —OR groups, where R is an alkyl group as defined herein. Examples of alkyoxy groups include methoxy groups, ethoxy groups, n-propoxy groups, i-propoxy groups, n-butoxy groups, i-butoxy groups, and s-butoxy groups.

The organically-modified, hybrid xerogel coatings of the present disclosure are used in methods for reducing condensation.

The xerogel surfaces are inexpensive, have desirable surface roughness/topography, and cover a range of wettabilities (e.g., 85 to 105°), as measured by the static water contact angle, and surface energies (e.g., 21 to 55 mN m−1).

Fluoroalkane functionality can be incorporated within the xerogel coatings using the sol-gel process. Mixed alkane and perfluoroalkane modifications can be incorporated from appropriate perfluoroalkyl- and alkyltrialkoxysilane precursors.

Alkane and fluoroalkane functionality can be incorporated within the xerogel coatings using the sol-gel process. Mixed alkane and perfluoroalkane modifications can be incorporated from appropriate perfluoroalkyl- and alkyltrialkoxysilanes.

It is possible to generate surface segregation into nm- and/or m scale structural features on surfaces containing hydrocarbon and fluorocarbon functionality from xerogel coatings prepared from sol-gel precursors incorporating 1 mole % C18 and 1 to 24 mole % tridecafluorooctyltriethoxysilane (TDF) in combination with C8 and 50 mole % TEOS. On the other hand, hybrid three-component xerogels made from combinations of 1,1,1trifluoropropyltrimethoxysilane (TFP) with phenyltriethoxysilane (PH), n-propyltrimethoxysilane (C3), or n-octyltriethoxysilane (C8) and with tetraethoxysilane (TEOS) as the third component gave uniformly smooth surfaces by time of flight-secondary ion mass spectrometry (ToF-SIMS), scanning electron microscopy (SEM), and atomic force microscopy (AFM).

There was no phase segregation and no distinct topographical features were apparent with short-chain perfluoroalkyltrialkoxysilanes and short-chain (e.g., chains of 3 and 8 carbons) alkyltrialkoxysilanes.

The organically-modified, hybrid xerogel coatings are used in methods for reducing condensation. The xerogel materials have tunable surface hydrophobicity and surface energies (by selection of appropriate sol-gel precursors) and are thinner (10-30 m) with higher elastic modulus than silicone films. When two or more layers of coating are applied, the thickness will proportionally increase (e.g. 20-60 m for 2 layers etc. . . . ).

An example of such a xerogel surface is incorporating 1 mole % of an n-octadecyltrimethoxysilane (C18) precursor in combination with n-octyltriethoxysilane (C8) and tetraethoxysilane (TEOS).

Other examples of xerogel surfaces include xerogel prepared from 1:4:45:50 mole % and 1:14:35:50 mole %, respectively, of C18, tridecafluoro-1,1,2,2tetrahydrooctyl-triethoxysilane (TDF), C8, and TEOS.

Other examples of xerogel surfaces include 50:50 mole % of C8, and TEOS.

Other examples of xerogel surfaces include 1:49:50 mole % of C18, C8, and TEOS.

Other examples of xerogel surfaces include 1:14:35:50 mole % of C18, tridecafluoro-1,1,2,2-tetrahydrooctyltriethoxysilane (TDF), C8, and TEOS.

The xerogel surfaces are optically transparent.

The xerogel require no “tie” coat, such as an adhesive or an adhesive made of double-sided sticky sheets, for bonding to a variety of surfaces.

In one embodiment, there are provided methods for reducing or preventing formation of water condensation on a solid surface, comprising providing a xerogel film as defined herein, on at least a portion of said surface.

In one embodiment, the xerogel is obtained by applying the sol-gel matrix or the composition as defined herein in a non-solid form (e.g. liquid or gel form), and as such the method does not require any crushing or other manipulation of a solid to coat the surface of an object for which reduction of condensation is desired.

In one embodiment, the method comprises providing a xerogel on at least a portion of said surface, wherein said xerogel is obtained by applying the composition as defined herein on said surface, and wherein said composition comprises two or more silanes, some of which having been partially hydrolyzed and/or condensed, and said composition further comprises a water miscible organic solvent.

For example, the incorporation of low levels (e.g., 1 to 5 mole %) of the long chain n-octadecyltriethoxysilane gave interesting results with respect to surface topography and the separation of phases on the xerogel surfaces. These surfaces were rougher (root-mean-square roughness>1 nm) and had chemically distinct phases as observed by IR microscopy and AFM.

The present disclosure uses a sol-gel matrix or a composition comprising same for coating a surface. The xerogel film is formed from the sol-gel obtained from hydrophobic silanes. The surface coatings are used in methods for reducing condensation. The coatings are two-three- or four-component ORMOSIL (organically modified silica) xerogel films (also referred to herein as hybrid films). The xerogel films can be formed by sol-gel methods, such as the methods disclosed herein.

In an embodiment, a condensation-reducing surface coating composition comprises a sol-gel matrix. The composition comprises two, three or four partially hydrolyzed silanes.

In another embodiment, the condensation-reducing coating composition consists essentially of a sol-gel matrix and the composition consists essentially of partially hydrolyzed silanes. In another embodiment, the condensation-reducing coating composition consists essentially of a sol-gel matrix and the composition consists essentially of three partially hydrolyzed silanes. In another embodiment, the condensation-reducing coating composition consists essentially of a sol-gel matrix and the composition consists essentially of four partially hydrolyzed silanes. In yet another embodiment, the condensation-reducing coating composition consists of a sol-gel matrix and the composition consists of two partially hydrolyzed silanes. In yet another embodiment, the condensation-reducing coating composition consists of a sol-gel matrix and the composition consists of three partially hydrolyzed silanes. In yet another embodiment, the condensation-reducing coating composition consists of a sol-gel matrix and the composition consists of four partially hydrolyzed silanes.

In an embodiment, a first silane is a long-chain alkyltrialkoxysilane, or a perfluoalkyltrialkoxysilane, a second silane is a shorter-chain alkyltrialkoxysilane, and a third silane is a tetraalkoxysilane.

In an embodiment, a first silane is a long-chain alkyltrialkoxysilane, a perfluoalkyltrialkoxysilane, or is selected from an aminoalkyltrialkyoxysilane, alkylaminoalkyltrialkoxysilane, and dialkylaminoalkyltrialkoxysilane. A second silane is a shorter-chain alkyltrialkoxysilane, or, if the first precursor component is an aminoalkyltrialkyoxysilane, alkylaminoalkyltrialkoxysilane, or dialkylaminoalkyltrialkoxysilane, then the second precursor is a long-chain alkyltrialkoxysilane. A third silane is a tetraalkoxysilane.

In another embodiment, where the first silane is a longchain alkyltrialkoxysilane, the sol-gel processed composition further comprises a fourth silane that is a perfluoroalkyltrialkoxysilane.

In an embodiment, the third silane makes up the remainder of the precursor composition.

In an embodiment, the three component silanes of said combination of silanes, sol-gel matrix, coating composition or xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with 20 mole % to 55 mole % of a shorter-chain alkyltrialkoxysilane (such as, but not limited to, n-propyltrimethoxysilane (C3) or n-octyltriethoxysilane (C8)) and a tetraalkoxysilane (such as, but not limited to, tetramethoxysilane (TMOS), tetraethoxysilane (TEOS), or tetraisopropoxysilane (TIPOS).

In an embodiment, the silanes of said combination of silanes, sol-gel matrix, coating composition or xerogel surface incorporate 1 mole % to 45 mole % of a long-chain perfluoroalkyltrialkoxysilane (where long-chain refers to eight (10) or more carbons such as, but not limited to, tridecafluorooctyltriethoxysilane (TDF) or tridecafluorooctyltrimethoxysilane) in combination with mole % to 55 mole % of a shorter-chain alkyltrialkoxysilane (such as, but not limited to, n-propyltrimethoxysilane (C3) or n-octyltriethoxysilane (C8)) and a tetraalkoxysilane (such as, but not limited to, tetramethoxysilane (TMOS), tetraethoxysilane (TEOS), or tetraisopropoxysilane (TIPOS)) are incorporated in the surface.

In an embodiment, the silanes of said combination of silanes, sol-gel matrix, coating composition or xerogel surface incorporate 1 mole % to 20 mole % of an aminoalkyl, alkylaminoalkyl-, or dialkylaminoalkyltrialkoxysilane (such as, but not limited to, aminopropyltriethoxysilane (AP), methylaminopropyltriethoxysilane (MAP), or dimethylaminopropyltriethoxysilane (DMAP)) in combination with 1 mole % to 45 mole % of a long-chain perfluoroalkyltrialkoxysilane (where long-chain refers to eight (8) or more carbons such as, but not limited to, tridecafluorooctyltriethoxysilane (TDF) or tridecafluorooctyltrimethoxysilane) and a tetraalkoxysilane (such as, but not limited to, tetramethoxysilane (TMOS), tetraethoxysilane (TEOS), or tetraisopropoxysilane (TIPOS)) are incorporated into the surface.

In an embodiment, the silanes of said combination of silanes, sol-gel matrix, coating composition or xerogel surface incorporate 1 mole % to 20 mole % of an aminoalkyl, alkylaminoalkyl-, or dialkylaminoalkyltrialkoxysilane (such as, but not limited to, aminopropyltriethoxysilane (AP), methylaminopropyltriethoxysilane (MAP), or dimethylaminopropyltriethoxysilane (DMAP)) in combination with 1 mole % to 45 mole % of a longer-chain alkyltrialkoxysilane (where longer-chain refers to eight (8) or more carbons, such as, but not limited to, n-octyltriethoxysilane (C8), n-dodecyltriethoxysilane (C12), or n-octadecyltriethoxysilane (C18)) and a tetraalkoxysilane (such as, but not limited to, tetramethoxysilane (TMOS), tetraethoxysilane (TEOS), or tetraisopropoxysilane (TIPOS)) are incorporated in the surface.

In an embodiment, the silanes of said combination of silanes, sol-gel matrix, coating composition or xerogel surface incorporate a first silane which is a shorter-chain alkyltrialkoxysilane, and a second silane which is a tetraalkoxysilane. In an embodiment, 50:50 mole % of said alkyltrialkoxysilane, and said tetraalkoxysilane are present.

In an embodiment, the silanes of said combination of silanes, sol-gel matrix, coating composition or xerogel surface incorporates a first silane which is a long-chain alkyltrialkoxysilane, a second silane which is a shorter-chain alkyltrialkoxysilane, and third silane which is a tetraalkoxysilane.

In an embodiment, the three-component silanes of said combination of silanes, sol-gel matrix, coating composition or xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with 20 mole % to 55 mole % of a shorter-chain alkyltrialkoxysilane (such as, but not limited to, n-propyltrimethoxysilane (C3) or n-octyltriethoxysilane (C8)) and further in combination with about 50 mole % of a tetraalkoxysilane (such as, but not limited to, tetramethoxysilane (TMOS), tetraethoxysilane (TEOS), or tetraisopropoxysilane (TIPOS)).

In an embodiment, the three-component silanes of said combination of silanes, sol-gel matrix, coating composition or xerogel surface incorporates about 1 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor in combination with about 49 mole % of a shorter-chain alkyltrialkoxysilane (such as, but not limited to, n-propyltrimethoxysilane (C3) or n-octyltriethoxysilane (C8)) and further in combination with about 50 mole % of a tetraalkoxysilane (such as, but not limited to, tetramethoxysilane (TMOS), tetraethoxysilane (TEOS), or tetraisopropoxysilane (TIPOS)).

In an embodiment, silanes of said combination of silanes, sol-gel matrix, coating composition or xerogel are a first silane which is a long-chain alkyltrialkoxysilane, a second silane component which is a perfluoalkyltrialkoxysilane, a third silane which is a shorter chain alkyltrialkoxysilane, and a fourth silane which is a tetraalkoxysilane.

In an embodiment, the four-component silanes of said combination of silanes, sol-gel matrix, coating composition or xerogel surface incorporates 0.25 mole % to 5.0 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor, in combination with 1 mole % to 45 mole % of a perfluoroalkyltrialkoxysilane (where perfluoroalkyltrialkoxysilane refers to tridecafluorooctadecyltriethoxysilane or tridecafluorooctyltrimethoxysilane, in combination with mole % to 55 mole % of a shorter-chain alkyltrialkoxysilane (such as, but not limited to, n-propyltrimethoxysilane (C3) or n-octyltriethoxysilane (C8)) and further in combination with about 50 mole % of a tetraalkoxysilane (such as, but not limited to, tetramethoxysilane (TMOS), tetraethoxysilane (TEOS), or tetraisopropoxysilane (TIPOS)).

In an embodiment, the four-component silanes of said combination of silanes, sol-gel matrix, coating composition or xerogel surface incorporates about 1 mole % of a long-chain alkyltrialkoxy silane (where long-chain refers to ten (10) or more carbons, such as, but not limited to, n-dodecyltriethoxysilane (C12) or n-octadecyltriethoxysilane (C18)) precursor, in combination with about 14 mole % of a perfluoroalkyltrialkoxysilane (where perfluoroalkyltrialkoxysilane refers to tridecafluorooctadecyltriethoxysilane or tridecafluorooctyltrimethoxysilane in combination with about 35 mole % of a shorter-chain alkyltrialkoxysilane (such as, but not limited to, n-propyltrimethoxysilane (C3) or n-octyltriethoxysilane (C8)), and further in combination with about 50 mole % of a tetraalkoxysilane (such as, but not limited to, tetramethoxysilane (TMOS), tetraethoxysilane (TEOS), or tetraisopropoxysilane (TIPOS)).

The sol-gel precursors are long-chain alkyltrialkoxysilanes, short-chain alkyltrialkoxysilanes, aminoalkyltrialkoxysilanes, alkylaminoalkyltrialkoxysilanes, dialkylaminoalkyltrialkoxysilanes, and perfluororalkyltrialkoxysilanes.

The sol-gel precursors can be obtained from commercial sources or synthesized by known methods.

The long-chain alkyltrialkoxysilane has a long-chain alkyl group and three alkoxy groups. The long-chain alkyltrialkoxysilane has the following structure:

(RO)₃—Si—R′

where, in this structure, R′ is a long-chain alkyl group and R is an alkyl group of an alkoxy group. The long chain alkyl group is a C₁₀ to C₃₀, including all integer numbers of carbons and ranges there between, alkyl group. The alkoxy groups are, independently, C₁, C₂, or C₃ alkoxy groups. The alkoxy groups can have the same number of carbons. The long-chain alkyltrialkoxysilane is present as a first component at from 0.25 mole % to 5.0 mole %, including all values to the 0.1 mole % and ranges there between, or as a second component at 1 mole % to 45 mole %, including all integer mole % values and ranges there between. Examples of suitable long-chain alkyltrialkoxysilanes include n-dodecyltriethoxysilane, n-octadecyltriethoxysilane, and n-decyltriethoxysilane.

The short-chain alkyltrialkoxysilane has the following structure:

(RO)₃—Si—R′

where, in this structure, R′ is a short-chain alkyl group and R is an alkyl group of an alkoxy group. The short-chain alkyltrialkoxysilane has a short-chain alkyl group and three alkoxy groups. The short-chain alkyl group is a C₃ to C₈, including all integer numbers of carbons and ranges there between, alkyl group The alkoxy groups are, independently, C₁, C₂, or C₃ alkoxy groups. The alkoxy groups can have the same number of carbons. The short-chain alkyltrialkoxysilane is present at 20 mole % to 55 mole %, including all integer mole % values and ranges there between. Examples of suitable short-chain alkyltrialkoxysilanes include n-propyltrimethoxy silane, n-butyltriethoxysilane, n-pentyltriethoxysilane, n-hexyltriethoxysilane, n-heptyltriethoxysilane, n-octyltriethoxysilane, and branched analogues thereof.

The aminoalkyltrialkoxysilane has an aminoalkyl group and three alkoxy groups. The aminoalkyltrialkoxysilane has the following structure:

(RO)₃—Si—R′—NH₂

where, in this structure, R′ is a an alkyl group of the aminoalkyl group and R is an alkyl group of an alkoxy group. The aminoalkyl group has a C₁ to C₁₀, including all integer numbers of carbons and ranges there between, aminoalkyl group. The alkoxy groups are, independently, C₁, C₂, or C₃ alkoxy groups. The alkoxy groups can have the same number of carbons. The aminoalkyltrialkoxy silane is present at 1 mole % to 20 mole %, including all integer mole % values and ranges there between. Examples of suitable aminoalkyltrialkoxysilanes include aminomethyltriethoxysilane, aminoethyltriethoxysilane, aminopropyltriethoxysilane, aminobutyltriethoxysilane, aminopentyltriethoxysilane, and aminohexyltriethoxysilane.

The alkylaminoalkyltrialkylsilane has an alkylamino group, aminoalkyl group, and three alkoxy groups. The alkylaminoalkyltrialkoxysilane has the following structure:

(RO)₃—Si—R′—NH—R′

where, in this structure, R′ is the alkyl group of the alkylamino group and R′ is a the alkyl group of the alkylaminoalkyl group and R is an alkyl group of a alkoxy group. The aminoalkyl group has a C₁ to C₁₀, including all integer numbers of carbons and ranges there between, alkyl group. The aminoalkyl group has a C₁ to C₁₀, including all integer numbers of carbons and ranges there between, alkyl group. The alkoxy groups are, independently, C₁, C₂, or C₃ alkoxy groups. The alkylaminoalkyltrialkoxysilane is present at 1 mole % to 20 mole %, including all integer mole % values and ranges there between. The alkoxy groups can have the same number of carbons. Examples of suitable alkylaminoalkyltrialkoxysilanes include methylaminoethyltriethoxysilane, methylaminopropyltriethoxysilane, methylaminobutyltriethoxysilane, methylaminopentyltriethoxysilane, methylaminohexyltriethoxysilane, and ethyl and propyl amino analogues thereof.

The dialkylaminoalkyltrialkoxysilane has the following structure:

(RO)₃—Si—R′—N—(R″)(R″)

where, in this structure, R′ and R′ are each an alkyl group of the alkylamino group and R′″ is the alkyl group of the dialkylaminoalkyl group and R is an alkyl group of a alkoxy group. The dialkylaminoalkyltrialkylsilane has a dialkylamino group, aminoalkyl group, and three alkoxy groups. The alkyl groups of the diaminoalkyl group are, independently, C₁ to C₁₀, including all integer numbers of carbons and ranges there between, alkyl groups. The dialkylamino alkyl groups can have the same number of carbons. The aminoalkyl group has a C₁ to C₁₀, including all integer numbers of carbons and ranges there between, alkyl group. The alkoxy groups are, independently, C₁, C₂, or C₃ alkoxy groups. The alkoxy groups can have the same number of carbons. The dialkylaminoalkyltrialkoxysilane is present at 1 mole % to 20 mole %, including all integer mole % values and ranges there between. Examples of suitable dialkylaminoalkyltrialkoxysilanes include dimethylaminoethyltriethoxysilane, dimethylaminopropyltriethoxysilane, dimethylaminobutyltriethoxysilane, dimethylaminopentyltriethoxysilane, dimethylaminohexyltriethoxysilane, and diethylamino and dipropylamino analogues thereof.

The perfluoroalkyltrialkoxysilane has the following structure:

(RO)₃—Si—R′

where, in this structure, R′ is a perfluoroalkylalkyl group and R is an alkyl group of an alkoxy group. The perfluoroalkyltrialkoxysilane has a perfluoroalkyl group and three alkoxy groups. The pefluoroalkyl group is a C₈ to C₃₀, including all integer numbers of carbons and ranges there between, alkyl group. The alkoxy groups are, independently, C₁, C₂, or C₃ alkoxy groups. The alkoxy groups can have the same number of carbons. The perfluoroalkyltrialkoxysilane is present at 1 mole % to 45 mole %, including all integer mole values and ranges therebetween. Examples of suitable perfluoroalkyltrialkoxysilanes include tridecafluorooctadecyltriethoxysilane and tridecafluorooctyltrimethoxysilane.

The tetraalkoxysilane has the following structure:

(RO)₃—Si—OR

where, in this structure, R is an alkyl group of an alkoxy group. The alkoxy groups are, independently, C₁, C₂, or C₃ alkoxy groups. The alkoxy groups can have the same number of carbons.

The sol-gel matrix or coating compositions comprise functional groups derived from the precursor silanes. For example, coatings formed using perfluoroalkyltrialkoxysilanes have perfluoroalkyl groups. The surface coatings also have residual silanol functional groups. The groups can be on the surface of the film or in the bulk matrix of the film.

The thickness of the xerogel can be varied based on the deposition method and/or parameters of the deposition process (e.g., concentrations of the precursor components). For example, the film can have a thickness of 1 micron to 35 microns, including all integer thickness values and ranges there between.

The sol-gel matrix surface coatings have desirable properties. For example, the surface roughness is greater than 1 nm. For example, the surface roughness is between 1 and 20 nm, including all values to the nm and ranges thereof.

As used herein, the total of the mol % when included in a recitation of amounts of silanes (or partially hydrolyzed silanes) in combinations, sol-gel, compositions or xerogel, as defined herein, is necessarily 100% of the total silane content. The total mol % amount is understood and selected by the skilled person to be 100% even if the total of the upper ranges of all components can numerically exceed 100%. The total mol % amount is also understood and selected by the skilled person to be 100% by adding the required mol % amount of tetraalkoxysilane to reach 100%.

In an embodiment, condensation-reducing surface coating composition comprises a sol-gel matrix made by a method comprising the following steps: forming a precursor composition comprising two, three or four sol-gel precursor components, coating the precursor composition on a surface such that a sol-gel matrix film is formed on the surface.

Generally, the precursor composition (referred to herein as a sol) is formed by combining two, three or four sol-gel precursor components and allowing the components to stand for a period of time in the presence of a catalyst such that a desired amount of hydrolysis and polymerization of the precursors occurs. This precursor composition is coated on a surface and said surface is allowed to stand for a period of time such that a xerogel film is formed. The determination of specific reaction conditions (e.g., mixing times, standing times, acid/base concentration, solvent(s)) for forming the xerogel film is within the purview of one having skill in the art.

In another aspect, the present disclosure provides methods for reducing or preventing formation of water condensation on a solid surface.

As used herein, condensation may preferably be referred to as the change in the state of water vapour to liquid water when in contact with a solid surface.

The surface is any surface were condensation can form. The surfaces can be materials such as metals (such as iron, aluminum, alloys, etc.), plastics, composites (such as fiberglass), glass, ceramic, wood, or other natural fibers. Examples of suitable surfaces include any surfaces like bathrooms, caravans, yachts, underground parking lots, cold storage rooms, water tanks, grain silos and food processing plants. Other examples of suitable surface include, but are not limited to, floors, roofs, ceilings, walls, windows, working structures, moving steel parts in a factory, electronic components, telecommunication devices, ship decks and the exterior of armoured vehicles.

In an embodiment, the method comprises the step of applying a coating of the condensation-reducing coating composition as described herein to at least a portion of a surface such that an ORMOSIL xerogel film is formed on the surface.

The coating of condensation-reducing coating composition can be applied by a variety of coating methods. Examples of suitable coating methods including spray coating, dip coating, brush coating, or spread coating.

The sol-gel matrix coating can be formed by acid-catalyzed hydrolysis and polymerization of the precursor components.

In an embodiment, the condensation-reducing precursor composition further comprises an acidic component that makes the pH of the composition sufficiently acidic so that the components undergo acid-catalyzed hydrolysis to form the sol-gel matrix. Examples of suitable acidic components include aqueous acids such as hydrochloric acid, hydrobromic acid and trifluoroacetic acid. Conditions and components required for acid-based hydrolysis of sol-gel components are known in the art.

After applying the coating of condensation-reducing coating composition, the coating is allowed to stand for a time sufficient to form the xerogel. Depending on the thickness of the coating, the standing time is, for example, from 1 hour to 72 hours including all integer numbers of hours and ranges there between and up to 1 or more days.

In an embodiment, the method is for reducing or preventing formation of water condensation on said surface, wherein said surface is in contact with a gaseous atmosphere comprising water vapor, and the temperature of said atmosphere is higher than the temperature of said surface. In one embodiment, said atmosphere comprises a relative humidity of 25% or more, at a temperature of from about 0 to about 200° C. Preferably the relative humidity is 75% or more, at a temperature of from about 4 to 40° C.

The steps of the methods described in the various embodiments and examples disclosed herein are sufficient to practice the methods of the present disclosure. Thus, in an embodiment, the method consists essentially of a combination of the steps of a method disclosed herein. In another embodiment, the method consists of such steps.

The following examples are presented to illustrate the present disclosure. They are not intended to limiting in any manner.

### Example 1

In this example, two- and three-component, hybrid xerogel surfaces that have high contact angles (>85°) and that perform as condensation-reducing surfaces are described. Entry 1 and 2 are comparative examples.

TABLE 1
Water contact angle and reduction of condensation
on hybrid xerogel surface

| | | Water contact | Condensation |
|---|---|---|---|
| | Sample | angle^{a} | reduction^{b} |
| Entry | (mole % of each component) | ° | % |
| 1 | Glass | 21 ± 1 | — |
| 2 | PDMSE | 109 | — |
| 3 | 50:50 C8/TEOS | 104 ± 2 | 12.5 |
| 4 | 50:50 C3/TEOS | 99 ± 2 | 21.9 |
| 5 | 50:50 TFP/TEOS | 85 ± 1 | n/a |
| 6 | 10:90 TDF/TEOS | 112 ± 1 | 15.6 |
| 7 | 20:80 TDF/TEOS | 109 ± 2 | 9.4 |
| 8 | 5:45:50 C18/C8/TEOS | 108.2 ± 0.9 | 9.4 |
| 9 | 4:46:50 C18/C8/TEOS | 105 ± 2 | 17.2 |
| 10 | 3:47:50 C18/C8/TEOS | 102 ± 4 | 12.5 |
| 11 | 2:48:50 C18/C8/TEOS | 108.3 ± 0.9 | 10.9 |
| 12 | 1:49:50 C18/C8/TEOS | 111.2 ± 0.2 | 12.5 |
| 13 | 10:40:50 TDF/C8/TEOS | 104 ± 3 | n/a |
| 14 | 20:30:50 TDF/C8/TEOS | 104 ± 3 | n/a |
| 15 | 30:20:50 TDF/C8/TEOS | 102 ± 2 | 10.9 |
| 16 | 40:10:50 TDF/C8/TEOS | 103 ± 4 | 14.1 |
| 17 | 1:49:50 DMAP/TDF/TEOS | 108 ± 1 | n/a |
| 18 | 2:48:50 DMAP/TDF/TEOS | 104 ± 2 | 7.8 |
| 19 | 3:47:50 DMAP/TDF/TEOS | 105 ± 1 | 7.8 |
| 20 | 4:46:50 DMAP/TDF/TEOS | 112 ± 2 | 6.3 |
| 21 | 5:45:50 DMAP/TDF/TEOS | 113.5 ± 0.8 | 5.7 |
| 22 | 10:40:50 DMAP/TDF/TEOS | 113 ± 1 | 7.8 |
| 23 | 0.5:49.5:50 DMAP/C8/TEOS | 102 ± 1 | 9.4 |
| 24 | 1.0:49.0:50 DMAP/C8/TEOS | 97.6 ± 0.2 | n/a |
| 25 | 1.5:48.5:50 DMAP/C8/TEOS | 96.7 ± 0.3 | 4.7 |
| 26 | 2.0:48.0:50 DMAP/C8/TEOS | 95.8 ± 0.2 | 4.3 |
| 27 | 1:49:50 C18/TDF/TEOS | 97 ± 1 | 11.4 |
| 28 | 2:48:50 C12/C8/TEOS | 108 ± 1 | 7.1 |
| 29 | 4:46:50 C12/C8/TEOS | 104 ± 2 | 3.1 |
| 30 | 5:45:50 C12/C8/TEOS | 105 ± 1 | 1.4 |
| 31 | 10:40:50 C12/C8/TEOS | 112 ± 1 | 2.9 |
| 32 | 20:30:50 C12/C8/TEOS | 113 ± 1 | n/a |

^{a}Mean of five (5) independent measurements for coatings store in air prior to measurement. ± one standard deviation.
^{b}Average of four (4) replicate measurements compare to an untreated surface.
n/a: not available

### Example 2

In this example, four-component, hybrid xerogel surfaces that have high contact angles (>95) and that perform as condensation-reducing surfaces are described. Entry 1 and 2 are comparative examples.

TABLE 2
Water conctact angle and reduction of condensation on
hybrid xerogel surface

| | | Water contact | Condensation |
|---|---|---|---|
| | Sample | angle^{a} | reduction^{b} |
| Entry | (mole % of each component) | ° | % |
| 1 | Glass | 21 ± 1 | — |
| 2 | PDMSE | 109 | — |
| 3 | 1:4:45:50 C18/TDF/C8/TEOS | 106.0 ± 0.2 | 1.4 |
| 4 | 1:14:35:50 C18/TDF/C8/TEOS | 106.1 ± 0.6 | 1.4 |
| 5 | 1:24:25:50 C18/TDF/C8/TEOS | 96.5 ± 0.3 | 4.3 |
| 6 | 0.5:1:48.5:50 DMAP/C18/C8/ | 102 ± 1 | 1.6 |
| | TEOS | | |
| 7 | 1.0:1:48.0:50 DMAP/C18/C8/ | 99 ± 1 | n/a |
| | TEOS | | |
| 8 | 1.5:1:47.5:50 DMAP/C18/C8/ | 96.7 ± 0.3 | 6.3 |
| | TEOS | | |
| 9 | 2.0:1:47.0:50 DMAP/C18/C8/ | 95.3 ± 0.2 | 4.7 |
| | TEOS | | |

^{a}Mean of five (5) independent measurements for coatings store in air prior to measurement. ± one standard deviation.
^{b}Average of four (4) replicate measurements compare to an untreated surface.
n/a: not available

A number of the two-component and all of the three- and four-component, hybrid xerogel surfaces of Tables 1 and 2 have values of the static water contact angle that are greater than 95°. However, the contact angle is not an indicator (either quantitatively or quantitatively) for the reduction of condensation on the surface because such a complex physical process is influenced by many other factors like surface roughness and the chemical nature of the hydrophobic layer.

Materials and Methods. Chemical Reagents. Deionized water was prepared to a specific resistivity of at least 18 MQ using a Barnstead NANOpure Diamond UV ultrapure water system. Tetraethoxysilane or tetraethyl orthosilicate (TEOS), n-propyltrimethoxysilane (C3), n-octadecyltrimethoxysilane (C18), n-octyltriethoxy-silane (C8), 3,3,3-trifluoropropyltrimethoxysilane (TFP), and tridecafluorooctyltriethoxysilane (TDF) were purchased from Gelest, Inc. and were used as received. Ethanol was purchased from Quantum Chemical Corp. Hydrochloric acid was obtained from Fisher Scientific Co. Borosilicate glass microscope slides were obtained from Fisher Scientific, Inc.

Sol Preparation. The sol/xerogel composition is designated in terms of the molar ratio of Si-containing precursors. Thus, a 50:50 C8/TEOS composition contains 50 mole % C8 and 50 mole % TEOS.

Sol TEOS. TEOS (3.96 g, 17.1 mmol, 3.35 mL), water (0.54 mL), ethanol (3.40 mL), and HCL (0.1 M, 15 L) were stoppered in a glass vial and stirred at ambient temperature for 6 hours.

Sol AP. AP (2.544 g, mmol) was added dropwise to a stirred mixture of 6.67 M HCl (2.000 mL) and ethanol (10.56 ml). Once addition was complete the solution was mixed via sonication at ambient temperature for 40 min.

10:90 AP/TEOS. A mixture of sol TEOS (3.353 mL) and sol AP (1.000 mL) was sonicated for 20 min at ambient temperature.

10:90 TMAP/TEOS. A mixture of TEOS (2.4 g, 64.1 mmol), TMAP (0.50 g, 1.2 mmol), water (1.8 mL), ethanol (3.0 mL), and 12 M HCl (5.2 .mu.L) was stirred at ambient temperature for 12 hours.

Sol DMAP. DMAP (1.054 g, 4.827 mmol) was added dropwise to a mixture of 6.67 M HCl (0.955 mL) and ethanol (4.668 mL). The resulting solution was stirred at ambient temperature for 40 min.

10:90 DMAP/TEOS. Sol DMAP (5.11 ml, 3.68 mmol) was added dropwise to sol TEOS (16.2 ml, 33.1 mmol). The mixture was stirred at ambient temperature for 20 min.

Sol MAP. MAP (2.000 g, 10.34 mmol) was added dropwise to 6.67 M HCl (2.04 mL, 15 mmol) and ethanol (10.0 mL). The resulting solution was stirred at ambient temperature for 40 min.

10:90 MAP/TEOS. Sol MAP (5.013 ml, 3.68 mmol) was added dropwise to sol TEOS (16.2 mL, 33.1 mmol). The resulting mixture was stirred at ambient temperature for 20 min.

50:50 TFP/TEOS. A mixture of TEOS (1.82 g, 7.8 mmol), TFP (1.70 g, 7.8 mmol), H₂O (0.563 ml, 31 mmol), and ethanol (3.5 ml, 60 mmol) was capped and sonicated at ambient temperature for 0.5 hours.

50:50 C3/TEOS. A mixture of C3 (2.0 g, 12.17 mmol), TEOS (2.53 g, 12.17 mmol), ethanol (4.0 mL), and 0.1 N HCl (2.1 mL, 0.21 mmol) was capped and stirred at ambient temperature for 8 hours.

25:25:50 TFP/C8/TEOS. A mixture of C8 (1.25 g, 4.5 mmol), TFP (1.0 g, 4.5 mmol), TEOS (1.8 g, 9.0 mmol), ethanol (3.0 mL), and 0.1 N HCl (1.6 mL, 0.16 mmol) was stirred at ambient temperature for 3 hours.

25:25:50 TFP/C3/TEOS. A mixture of C3 (0.93 g, 4.5 mmol), TFP (1.0 g, 4.5 mmol), TEOS (1.87 g, 9.0 mmol), ethanol (3.0 mL), and 0.1 N HCl (1.6 mL, 0.16 mmol) was stirred at ambient temperature for 3 hours.

50:50 C8/TEOS. A mixture of TEOS (2.70 g, 13 mmol), C8 (3.59 g, 13 mmol), ethanol (5.0 mL, 87 mmol) and 0.1 N HCl (1.6 mL, 0.16 mmol) was capped and stirred at ambient temperature for 24 hours.

5:45:50 C18/C8/TEOS. A mixture of C18 (0.269 g, 0.72 mmol, 0.305 mL), C8 (1.79 g, 6.48 mmol, 2.03 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

4:46:50 C18/C8/TEOS. A mixture of C18 (0.215 g, 0.58 mmol, 0.244 mL), C8 (1.83 g, 6.62 mmol, 2.08 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

3:47:50 C18/C8/TEOS. A mixture of C18 (0.161 g, 0.43 mmol, 0.183 mL), C8 (1.87 g, 6.77 mmol, 2.12 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

2:48:50 C18/C8/TEOS. A mixture of C18 (0.108 g, 0.29 mmol, 0.122 mL), C8 (1.91 g, 6.91 mmol, 2.17 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

1:49:50 C18/C8/TEOS. A mixture of C18 (0.054 g, 0.14 mmol, 0.061 mL), C8 (1.95 g, 7.06 mmol, 2.21 mL), TEOS (1.50 g, 7.20 mmol, 1.61 mL), 0.1 N HCl (0.91 mL, 0.09 mmol), and isopropanol (4.62 mL), was stirred at ambient temperature for 24 hours.

10:90 TDF/TEOS. TDF (0.288 g, 0.533 mmol, 0.213 mL), and TEOS (1.0 g, 4.80 mmol, 1.07 mL) were mixed. Ethanol (1.77 mL), and HCl (0.288 mL, 0.1 M), were added and the resulting solution was stirred at ambient temperature for 24 hours. At this time a 0.400 mL aliquot was removed and spun cast onto a glass microscope slide.

20:80 TDF/TEOS. TDF (0.612 g, 1.2 mmol, 0.453 mL), and TEOS (1.07 g, 4.08 mmol) were mixed. Ethanol (2.0 mL), and HCl (0.583 mL, 0.1 M), were added and the resulting solution was stirred at ambient temperature for 24 hours. At this time a 0.400 mL aliquot was removed and spun cast onto a glass microscope slide.

10:40:50 TDF/C8/TEOS. C8 (1.06 g, 3.84 mmol, 1.21 mL), TDF (0.49 g, 0.96 mmol, 0.363 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

20:30:50 TDF/C8/TEOS. C8 (0.79 g, 2.88 mmol, 0.90 mL), TDF (0.98 g, 1.92 mmol, 0.725 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

30:20:50 TDF/C8/TEOS. C8 (0.53 g, 1.92 mmol, 0.60 mL), TDF (1.47 g, 2.88 mmol, 1.08 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

40:20:50 TDF/C8/TEOS. C8 (0.26 g, 0.26 mmol, 0.26 mL), TDF (1.96 g, 3.84 mmol, 1.45 mL), and TEOS (1.0 g, 4.80 mmol, 1.07 mL) were mixed. Ethanol (3.2 mL), and HCl (0.52 mL, 0.1 M), were added and the resulting solution was stirred at ambient temperature for 24 hours. At this time a 0.400 mL aliquot was removed and spun cast onto a glass microscope slide.

5:5:90 DMAP/TDF/TEOS. Sol DMAP (2.489 ml, 1.792 mmol) was added dropwise to a stirring solution of TDF (0.915 g, 1.792 mmol), TEOS (6.72 g, 32.26 mmol), ethanol (5.039 ml), and 0.1M HCl (2.517 ml). The resulting mixture was stirred at ambient temperature for 24 hours.

2:48:50 C12/C8/TEOS. C12 (0.214 g, 0.72 mmol), C8 (5.04 g, 17.3 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

4:46:50 C12/C8/TEOS. C12 (0.418 g, 1.44 mmol), C8 (4.579 g, 16.56 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

5:45:50 C12/C8/TEOS. C12 (0.523 g, 1.80 mmol), C8 (4.35 g, 12.4 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

10:40:50 C12/C8/TEOS. C12 (1.046 g, 3.60 mmol), C8 (3.981 g, 14.40 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

20:30:50 C12/C8/TEOS. C12 (2.092 g, 7.20 mmol), C8 (2.986 g, 10.80 mmol), TEOS (3.750 g, 18.0 mmol), and isopropanol (11.55 mL) were mixed together followed by the addition of 0.1 M HCl (2.268 mL). The resulting solution was stirred at ambient temperature for 24 hours.

1:49:50 C18/TDF/TEOS. C18 (0.135 g, 0.36 mmol), TDF (9.003 g, 17.64 mmol), TEOS (3.750 g, 18.0 mmol), and ethanol (10.90 mL) were mixed together followed by the addition of 0.1 M HCl (2.268 mL). The resulting solution was stirred at ambient temperature for 24 hours.

1:1:48:50 C18/TDF/C8/TEOS. C18 (0.135 g, 0.36 mmol), TDF (0.184 g, 0.36 mmol), C8 (3.750 g, 18.0 mmol), TEOS (3.750 g, 18.0 mmol), and ethanol (8.47 mL) were mixed together followed by the addition of 0.1 M HCl (2.268 mL). The resulting solution was stirred at ambient temperature for 24 hours.

1:4:45:50 C18/TDF/C8/TEOS. C18 (0.135 g, 0.36 mmol), TDF (0.735 g, 1.44 mmol), C8 (4.479 g, 16.2 mmol), TEOS (3.750 g, 18.0 mmol), and ethanol (11.9 mL) were mixed together followed by the addition of 0.1 M HCl (2.268 mL). The resulting solution was stirred at ambient temperature for 24 hours.

1:9:40:50 C18/TDF/C8/TEOS. C18 (0.135 g, 0.36 mmol), TDF (1.654 g, 3.24 mmol), C8 (3.981 g, 14.4 mmol), TEOS (3.750 g, 18.0 mmol), and ethanol (11.9 mL) were mixed together followed by the addition of 0.1 M HCl (2.268 mL). The resulting solution was stirred at ambient temperature for 24 hours.

1:14:35:50 C18/TDF/C8/TEOS. C18 (0.135 g, 0.36 mmol), TDF (2.572 g, 5.04 mmol), C8 (3.484 g, 12.6 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

1:19:30:50 C18/TDF/C8/TEOS. C18 (0.135 g, 0.36 mmol), TDF (3.491 g, 6.84 mmol), C8 (2.986 g, 10.8 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

1:24:25:50 C18/TDF/C8/TEOS. C18 (0.135 g, 0.36 mmol), TDF (4.410 g, 8.64 mmol), C8 (2.488 g, 9.0 mmol), TEOS (3.750 g, 18.0 mmol), and ethanol (11.46 mL) were mixed together followed by the addition of 0.1 M HCl (2.268 mL). The resulting solution was stirred at ambient temperature for 24 hours.

0.5:1:48.5:50 DMAP/C18/C8/TEOS. C18 (0.135 g, 0.36 mmol), C8 (4.828 g, 17.46 mmol), TEOS (3.750 g, 18.0 mmol), and ethanol (11.835 mL) were mixed together followed by the addition of 0.1 M HCl (2.268 mL). Sol DMAP (0.249 mL, 0.18 mmol) was then added and the resulting solution was stirred at ambient temperature for 24 hours.

Preparation of 1:1:48:50 DMAP/C18/C8/TEOS. C18 (0.135 g, 0.36 mmol), C8 (4.778 g, 17.28 mmol), TEOS (3.750 g, 18.0 mmol), and ethanol (11.64 mL) were mixed together followed by the addition of 0.1 M HCl (2.268 mL). Sol DMAP (0.499 mL, 0.36 mmol) was then added and the resulting solution was stirred at ambient temperature for 24 hours.

1.5:1:47.5:50 DMAP/C18/C8/TEOS. C18 (0.135 g, 0.36 mmol), C8 (4.728 g, 17.10 mmol), TEOS (3.750 g, 18.0 mmol), and ethanol (11.45 mL) were mixed together followed by the addition of 0.1 M HCl (2.268 mL). Sol DMAP (0.748 mL, 0.54 mmol) was then added and the resulting solution was stirred at ambient temperature for 24 hours.

2:1:47:50 DMAP/C18/C8/TEOS. C18 (0.135 g, 0.36 mmol), C8 (4.678 g, 16.92 mmol), TEOS (3.750 g, 18.0 mmol), and ethanol (11.26 mL) were mixed together followed by the addition of 0.1 M HCl (2.268 mL). Sol DMAP (0.997 mL, 0.723 M) was then added and the resulting solution was stirred at ambient temperature for 24 hours.

Xerogel Film Formation. For the water contact angle experiments, xerogel films were formed by spin casting 400 μL of the sol precursor onto 25-mm×75-mm glass microscope slides. The slides were soaked in piranha solution for 24 hours, rinsed with copious quantities of deionized water then soaked in isopropanol for 10 minutes, were air dried and stored at ambient temperature. A model P6700 spincoater was used at 100 rpm for 10 seconds to deliver the sol and at 3000 rpm for 30 seconds to coat. All coated surfaces were dried at ambient temperature for at least 7 days prior to analysis. For the condensation experiments, xerogel films were formed by painting with a foam brush on 60-mm×62-mm×4-mm and 70-mm×62-mm×4-mm stainless steel coupons (grade 308). Coupons were washed with deionised water, isopropanol and hexane before being air dried and store at ambient temperature. All coated surfaces were dried at ambient temperature for 48 hours prior to analysis.

Comprehensive Contact Angle Analysis. The xerogel films were stored in air prior to characterization. Comprehensive contact angle analyses were performed in air. The approximate sampling depth of the contact angle technique is 5 Å. Up to thirteen different diagnostic liquids were utilized for the analysis of each sample: water, glycerol, formamide, thiodiglycol, methylene iodide, 1-bromonaphthalene, 1-methylnaphthalene, dicyclohexyl, n-hexadecane, n-tridecane, n-decane, noctane, and n-heptane. Liquid/vapor surface tensions of these liquids were determined directly; reference values for the liquid/vapor surface tensions are not used. The technique of “advanced angle” analysis was used, wherein a sessile drop of liquid (8-15 L depending on the viscosity of the liquid) is placed on the sample surface and the angle of contact between the liquid and the solid is measured with a contact angle goniometer (Raine-Hart, Model NRL 100); both sides of the droplet profile are measured.

Static water contact angles were measured by the sessile drop technique where the angle between a 15 L drop of water and the xerogel surface was measured with a contact angle goniometer (Rame-Hart, Model NRL 100); both sides of the droplet profile were measured.

Condensation experiments. For each xerogel composition, two 60-mm×62-mm×4-mm and two 70-mm×62-mm×4-mm stainless steel coupons where coated on both sides, dried for 48 hours and chilled at −4° C. for 16 hours. The cold coupons were loaded three at a time on horizontal supports above glass dishes in a 10.4 L atmospheric test chamber (developed in house). The coupons were subjected to a closed atmosphere at 30° C. with 95% relative humidity for 10 minutes. After this time, the coupons were weighted to assess the amount of humidity condensed on the surface and the glass dishes were surveyed to insure that condensation did not drip from the surface. The amount of water condensed on the surface was compared to the amount of water condensed on an uncoated stainless steel coupon in order to quantify the condensation-reducing property of the different xerogel film compositions. All xerogel compositions were tested four times to insure statistical reproducibility in the results.

Results. Xerogel Surfaces. A series of xerogel surfaces containing C3, C12, C18, TFP, TDF, C8, DMAP and TEOS were prepared. The xerogel films prepared by spin coating were 1 to 2 m thick as measured by profilometry. All of the xerogel films prepared were optically transparent. The xerogel surfaces were aged in air at ambient temperature for 2 to 7 days and were then examined by comprehensive advanced contact angle analyses to give values of the critical surface tension and the surface free energy. Static water contact angles, were measured for all xerogel surfaces described. Condensation experiments were performed with stainless stell coupons coated with most xerogel surfaces described.

Scanning electron microscopy (SEM) studies of several xerogel surfaces indicate that these surfaces are uniform, uncracked, and topographically smooth when dry. Time-of-flight, secondary-ion mass spectrometry (ToF-SIMS) studies show that there is no phase segregation of fluorocarbon and hydrocarbon groups on the mm scale in a 25:25:50 trifluoropropyl-trimethoxysilane/C8/TEOS xerogel.

The nature of the cross-linking and functional group distribution in the xerogels differs from that of fluorinated block copolymers that undergo surface reorganization upon exposure to water. Contact with water did not change the relative intensity of the silanol bands in the surface regions (data not shown) suggesting that further cross-linking of the surface is not responsible for the change.

Xerogel surfaces can be fine-tuned to provide surfaces with different wettability and different condensation-reducing properties. The topography of the xerogel surfaces can also be fine-tuned by the incorporation of a long-chain alkyl component and varying amounts of the polyfluorinated TDF. The formulation and coating of these TDF-containing xerogel surfaces require no special attention or preparation (pre-patterning). Depositing the xerogel by spin coating leads to self-segregation of hydrocarbon and fluorocarbon domains.

The hydrophobic xerogel films have good to high potential as condensation-reducing surfaces. However, xerogel films containing amino groups (such as DMAP) are not as efficient as the all alkane and fluoroalkane compositions despite the observation that they also have significant contact angles. This may be explained by the hydrophilic property of the amines.

We have observed that when condensation forms on the hydrophobic xerogel film, water droplets are smaller and more uniformly distribute compare to the condensation droplets on untreated stainless steel.

### Example 3

### Substrates and Surface Preparation

Surfaces are clean and as dry as conditions permit. For clean surfaces, the surface can be wiped with a cloth and isopropanol prior to coating. Preferably, remove any previous special use coatings before application. Employ adequate methods to remove dirt, dust, oil, wax, grease and all other contaminants that could interfere with adhesion of the coating.

### Application Equipment

Two coats of composition may be used. Allow coating to tack over between coats. Tack time will vary (about 1 hour). Sanding of the coating to remove surface imperfections may be accomplished after 24 hours by using a 220 or 350 grit sanding block. Brush: Use a foam brush. Roller: Use a smooth or super smooth foam type roller and roller pan. Coat small areas approximately 3 square ft. avoiding extensive re-rolling. Spray gun: Use a spray gun equipped with a 1.1 mm needle under only 10 psi pressure. Apply back and forth vertically then horizontally.

While the disclosure has been particularly shown and described with reference to specific embodiments (some of which are preferred embodiments), it should be understood by those having skill in the art that various changes in form and detail may be made therein without departing from the present disclosure as disclosed herein.

1. A method for reducing or preventing formation of water condensation on a solid surface, the method comprising
providing a sol-gel matrix from silanes;
coating said sol-gel matrix on said solid surface; and
allowing the coated sol-gel matrix to stand and provide a xerogel film formed on said solid surface.

2. The method of claim 1, wherein said sol-gel matrix is obtained by mixing a combination of said silanes and a catalyst that partially hydrolyzes alkoxy groups on the silanes.

3. The method of claim 2, wherein the molar amount of catalyst that partially hydrolyzes alkoxy groups is about 0.001 mol % to about 10 mol %.

4. The method of claim 1, wherein said -sol-gel matrix is prepared by partially hydrolyzing said silanes.

5. The method of claim 1, wherein said sol-gel matrix is prepared by partially hydrolyzing two-, or three-silanes.

6. The method of claim 1, wherein said sol-gel matrix is prepared by partially hydrolyzing a first silane which is a short chain alkyltrialkoxysilane, and a second silane which is a tetraalkoxysilane, wherein said short-chain alkyltrialkoxysilane has the following structure:
(RO)₃—Si—R′
wherein, R′ is an alkyl group of C₃ to C₈, and each R is independently an alkyl group of C₁, C₂, or C₃; and
said tetraalkoxysilane has the following structure:
(RO)₃—Si—OR
wherein, each R is independently an alkyl group of C₁, C₂, or C₃.

7. The method of claim 6, wherein said sol-gel matrix is prepared by further partially hydrolyzing a perfluoroalkyltrialkoxysilane, wherein said perfluoroalkyltrialkoxysilane has the following structure:
(RO)₃—Si—R″
wherein R″ is a perfluoroalkylalkyl group of C₈ to C₃₀ and each R is independently an alkyl group of C₁, C₂, or C₃.

8. The method of claim 6, wherein said sol-gel matrix is prepared by further partially hydrolyzing a long-chain alkyltrialkoxysilane, wherein said long-chain alkyltrialkoxysilane has the following structure:
(RO)₃—Si—R′″
wherein R′″ is an alkyl group of C₁₀ to C₃₀ and each R is independently an alkyl group of C₁, C₂, or C₃

9. The method of claim 1, wherein said sol-gel matrix is prepared by partially hydrolyzing n-propyltrimethoxysilane (C3) and tetraethoxysilane (TEOS); n-octyltriethoxy-silane (C8) and TEOS, n-octadecyltrimethoxysilane (C18), C8, and TEOS, tridecafluorooctyltriethoxysilane (TDF), C₈, and TEOS or C₁₈, TDF, and TEOS.

10. The method of claim 1, wherein said sol-gel matrix is in a composition comprising an organic solvent.

11. A surface coating composition for reducing or preventing formation of water condensation on a surface, said composition comprising a sol-gel matrix comprising partially hydrolyzed silanes.

12. The surface coating composition of claim 11, wherein said sol-gel matrix comprises two or more partially hydrolyzed silanes.

13. The surface coating composition of claim 11, wherein said sol-gel matrix comprises two-, or three-partially hydrolyzed silanes.

14. The surface coating composition of claim 11, comprising a first silane which is a shorter-chain alkyltrialkoxysilane, and a second silane which is a tetraalkoxysilane, wherein
said short-chain alkyltrialkoxysilane has the following structure:
(RO)₃—Si—R′
wherein, R′ is an alkyl group of C₃ to C₈, and each R is independently an alkyl group of C₁, C₂, or C₃; and
said tetraalkoxysilane has the following structure:
(RO)₃—Si—OR
wherein, each R is independently an alkyl group of C₁, C₂, or C₃.

15. The surface coating composition of claim 14, further comprising a perfluoroalkyltrialkoxysilane, wherein
said perfluoroalkyltrialkoxysilane has the following structure:
(RO)₃—Si—R″
wherein R″ is a perfluoroalkylalkyl group of C₈ to C₃₀ and each R is independently an alkyl group of C₁, C₂, or C₃.

16. The surface coating composition of claim 15, further comprising a long-chain alkyltrialkoxysilane, wherein
said long-chain alkyltrialkoxysilane has the following structure:
(RO)₃—Si—R′″
wherein R′″ is an alkyl group of C₁₀ to C₃₀ and each R is independently an alkyl group of C₁, C₂, or C₃.

17. The surface coating composition of claim 15, comprising 1 mole % to 45 mole % of said perfluoroalkyltrialkoxysilane, 20 mole % to 55 mole % of said shorter-chain alkyltrialkoxysilane, and wherein said tetraalkoxysilane comprises the remainder mol % to a total of 100 mol % of the surface coating composition.

18. The surface coating composition of claim 16, comprising 0.25 mole % to 5.0 mole % of said long-chain alkyltrialkoxy silane, 20 mole % to 55 mole % of said shorter-chain alkyltrialkoxysilane, and wherein said tetraalkoxysilane comprises the remainder mol % to a total of 100 mol % of the surface coating composition.

19. The surface coating composition of claim 11, comprising n-propyltrimethoxysilane (C3) and tetraethoxysilane (TEOS); n-octyltriethoxy-silane (C8) and TEOS, n-octadecyltrimethoxysilane (C18), C8, and TEOS, tridecafluorooctyltriethoxysilane (TDF), C8, and TEOS or C18, TDF, and TEOS.

20. The surface coating composition of claim 11, further comprising an organic solvent.
